(19) United States
(12) Patent Application Publication
(10) Pub. No.: US 2010/0039804 A1
(43) Pub. Date: Feb. 18, 2010

(54) ILLUMINATING DEVICE

(75) Inventors: Wolfgang Otto Budde, Aachen (DE); Hans-Peter Loebl, Monschau-Imgenbroich (DE); Joseph Hendrik Anna Maria Jacobs, Eygelshoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,397

(22) PCT Filed: Dec. 17, 2007
(86) PCT No.: PCT/IB07/55179

§ 371 Date: Jun. 16, 2009

(30) Foreign Application Priority Data
Dec. 20, 2006 (EP) 06126707.6

(51) Int. Cl. F21V 9/00; H01J 1/62; G01J 3/46

(52) U.S. Cl. 362/231; 313/504; 356/402

(57) ABSTRACT

The invention relates to an illuminating device (10) for illuminating an object, with a lighting element (20) and an inspection element (30), wherein the lighting element (20) comprises at least one first light emitting mean (21), wherein the first light emitting mean (21) is emitting light with a first spectrum (22), wherein the inspection element (30) comprises at least one second light emitting mean (31), wherein the second light emitting mean (31) is emitting light with a second spectrum (32), wherein the second spectrum (32) is essentially separated from the first spectrum (22), with an illuminating mode, operating only the lighting element (20), with an inspection mode, operating the lighting element (20) and the inspection element, and the superposition of the light of the first (21) and the second light emitting mean (31) yields a result light.

This invention relates to an illuminating device for illuminating an object.

In horticultural plant production greenhouses are often equipped with artificial light sources to extend the day length to grow plants over an extended time period of the year. This allows a producer to bring plants to the market on demand. Additionally, the artificial light is used in greenhouses without excess to day light where plants are often grown under complete control of the light flux and all other relevant parameters for the growth. The growth of the plants is thereby not only depending on the amount of light, but also on the spectral distribution of the light. It is known that chlorophyll, which is contained in the green leaves of plants, performs photosynthesis, absorbing selective blue and red light components of the sunlight. Therefore, efficient lamps should predominantly poses emission spectra, which fit to the absorption spectra of the most common pigments of plants.

In the JP 10/178,901 an artificial light source is described, which comprises a three wavelength area fluorescent lamp and a far infrared light LED. Unfortunately, the fluorescent lamp is not matched well enough with the absorption spectra of the plants. Furthermore, the described light source is known to be costly and extremely inefficient and therefore not appropriate for horticultural plant productions in greenhouses.

In the GB 2382014 A an extensive series of experiments is described, wherein plants are irradiated with light generated by an LED array. Only two types of LEDs where used, which either had a peak wavelength within the red or the blue optical spectrum. These experiments showed that the illumination of the plants with light which does not comprise a broad spectrum nevertheless achieves satisfying growth of the plants. Unfortunately, the human inspection of the plant growth is hardly possible under these artificial lighting conditions. Thus, the invention has for its object to eliminate the above mentioned disadvantages. In particular it is an object to the invention to provide an efficient illumination device, which nevertheless allows human inspection of the illuminated object.

This object is achieved by an illuminating device for illuminating an object as taught by claim 1 of the present invention. Advantage embodiments of the illumination device for illuminating an object are defined in the subclaims.

The object of the invention is achieved by an illuminating device for illuminating an object, with a lighting element and an inspection element, wherein the lighting element comprises at least one first light emitting mean, wherein the first light emitting mean is emitting light with a first spectrum, wherein the inspection element comprises at least one second light emitting mean, wherein the second light emitting mean is emitting light with a second spectrum, wherein the second spectrum is essentially separated from the first spectrum, with an illuminating mode, operating only the lighting element, with an inspection mode, operating the lighting element and the inspection element, and the superposition of the light of the first and the second light emitting mean yields a result light.

The described illuminating device is advantageous in all applications where different light conditions are used for functional and inspection purpose. In the illuminating mode only the lighting element is operated and therefore just the first light emitting mean is emitting light of the first spectrum. This first spectrum should be adjusted to the needs of the illuminated object. However, for a human or a machine an inspection of the object is hardly possible under these artificial light conditions. To overcome this disadvantage the illumination device comprises the inspection mode. During the inspection mode the lighting element as well as the inspection element is operated. Through the superposition of the light of the first and the second light emitting mean a result light is achieved.

In a preferred embodiment, the result light is a white light and/or comprises a white spectrum. A white light, as it is known from daylight or black body radiation with a high color temperature, is the most known type of light, being emitted by those light sources surrounding humans in their daily work. Therefore it is appropriate, that in the inspection mode the result light comprises a white spectrum, which enables a human to inspect the object under known conditions.

In a preferred embodiment of the illuminating device the lighting element comprises at least one third light emitting mean, wherein the third light emitting mean is emitting light with a third spectrum, wherein the third spectrum is essentially separated from the first and the second spectrum. It is known that the sheer growth of a plant is mainly depending on the amount of light, possessing the wavelength absorbed by Chlorophyll A or B. To achieve a generous growth of the plant the light emitting element may consist of at least two types of light emitting means, which are emitting at different wavelength. It is preferred that the first spectrum comprises a peak wavelength within the red optical spectrum between 600 nm to 700 nm. The third spectrum of the third light emitting mean should comprise a peak wavelength within the blue optical spectrum between 400 nm to 500 nm. The combined light flux of the first and the third light emitting mean on the one hand enables the plant to grow properly and on the other hand reduces the integral costs for illuminating the horticultural application. Said advantage is achieved by the absence of light within the green spectrum, which would not be absorbed by the plant and in the best case could just be used to heat the green house.

In a preferred embodiment the light flux emitted by the first and the third light emitting mean would be divided to approximately 80% to 90% red light and 10% to 20% blue light. The so achieved light flux is unsuitable for humans to inspect the plant growth. Therefore the invention uses the inspection element, which comprises the second light emitting mean. In a preferred embodiment the second spectrum of the second light emitting mean comprises a peak wavelength within the green optical spectrum between 500 nm to 600 nm. By operating the illumination device in the inspection mode the green light is added to the already emitted red and blue light flux. By superposition of the three different colored light fluxes a result light or rather a white light is generated.

Advantageously, any of the first, the second and/or the third light emitting mean may be a LED, an OLED, a gas discharge lamp, a high intensity discharge lamp, an incandescent lamp, a fluorescent lamp or a high pressure sodium lamp. LEDs (Light Emitting Diode) have the advantage that their spectrum can be designed such that it exactly meets the requirements of plants. The also applicable organic light emitting diode (OLED) is a special type of a light emitting diode (LED), in which the emissive layer comprise a thin film of certain organic components. The advantage of the OLED is that it is a homogeneous large area light source with potentially low cost and high efficiency and hence, OLEDs are better suited for horticulture applications where the total cost of ownership is important. These OLEDs utilize current flowing through a thin-film of organic material to generate light. The color of light being emitted and the efficiency of the energy conversion from current to light are determined by the composition of the organic thin-film material.

The OLEDs comprise a substrate material as a carrier layer, which may be made of glass or an organic material or from non transmittive materials such as metal foils. Onto this carrier layer usually a thin layer of a transparent Indium-Tin-Oxide (ITO) is applied, forming the anode. Furthermore, organic light emitting diodes consist of at least one very thin layer with a layer thickness of approx. 5-500 nm of organic substances. The OLED is regularly completed with a layer of Aluminum, forming the cathode, whereas the Aluminum layer features a thickness of approx. 100 nm and thus a thickness like the ITO-layer. Aluminum of such a thickness works as a mirror, such that the emission is through the transparent ITO anode and the transparent substrate only. If the cathode metal is thin enough to be partially transparent, part of the light may also be emitted through the cathode.

It is known, that the use of a large amount of blue light results in a tall plant whereas the use of a small amount of blue light results in a small and compact plant. Therefore the way and the manner of the growing of the plant may easily be controlled by using suitable light emitting means like the named LED, OLED or gas discharge lamp. Especially LEDs and OLEDS have shown to be advantageous, because their emission spectrum can be tuned to match the absorption spectrum of Chlorophyll A or B.

In another embodiment either the lighting element or the inspection element comprises a driver mean being connected with a source. By integrating parts of the power supply for the light emitting means in the lighting or inspection element an individual supply of current and voltage to each light emitting mean is possible. It is preferred that the first and the third light emitting mean integrated in the lighting element comprise an individual driver. So in a case, where different sorts of plants are grown, the illumination of the lighting element may individually be controlled. This is especially advantageous, if a number of illumination devices are mounted into different sections of a greenhouse where a number of different plants are grown. So depending on the type of plants OLEDs or LEDs with different emission spectra and therefore different demands to their power supplies may be used. In contrast to this modular design the use of just one power supply for a number of illumination devices has the advantage of being highly cost efficient.

The driver mean may include a current amplifying circuit and a wave generating and controlling circuit, which outputs the desired waveform (for example: square waves, triangular waves, sine waves or pulses). Also, the waveform's amplitude, frequency and duty ratio are adjustable by the waveform generating and controlling circuit.

Especially for horticultural applications in greenhouses a large area has to be illuminated. Therefore it is appropriate to use a number of illuminating devices producing the needed light flux. Furthermore, it is appropriate to integrate more than one first or second light emitting mean into a lighting element. Thereby one lighting element may for example be used to illuminate a single role of plants or seeds in a greenhouse. As LEDs are point like light sources, a great number of them is needed to illuminate an area of large size. In contrast thereto an OLED comprises a planar structure and may theoretically build to great expands. Nevertheless, the production of OLEDs with a smaller size, like 30×30 cm is technological easier to produce and an exchange in case of a failure of one OLED can easier be achieved. Therefore it is preferred that the lighting element comprises of a number of OLEDs, which may be turned on and off individually. Thus, the amount of the light generated by the light emitting means may be tuned to the requirements of the plants. If the number of OLEDs in the array is not too high, the lighting element combines the advantages of a homogeneous light distribution with the possible individual adjustment of the light output. Under these conditions it is advantageous if the number of the first and the third light emitting means are larger than the number of the second light emitting means. The last said means will only be activated in the inspection mode. The light level typically needed for growing conditions is above the needed light level for inspection.

Furthermore, the superimposed light of the first, the second and the third light emitting mean must yield a white light. Thus, the first and the third light emitting mean are dimmed in order to match the output level of the second light emitting mean. Preferably, the illuminating device comprises an analyzing element, detecting a light output of the lighting element and adjusting the light output to an output level of the inspection element. The analyzing element measures the light flux of the lighting element and dims the first and the third light emitting means in such a way that the superimposed light of all light emitting means comprises the white spectrum.

Advantageously, the illuminating device comprises a color sensor element, detecting a reflected spectrum from the object, being illuminated in the illuminating mode or the inspection mode. The color sensor element may for example be a CCD device, which surveys the spectrum of the reflected light. Especially, in horticultural applications the color sensor element may achieve multiple information about the plants by inspecting the reflected light. For example the color sensor element may automatically determine whether fruits, growing in horticulture applications, are mature. Preferably, this information is send to a central control system, which also drives and/or controls the illumination device. This enables on the one hand the owner of the greenhouse to be informed to harvest the fruits and on the other hand to change the spectral distribution of the light being emitted by the lighting element.

In another preferred embodiment the color sensor element communicates with the lighting element, wherein the color sensor element sends a control information to the lighting element for adjusting an output level of the light with the first spectrum and the third spectrum. In the inspection mode, the color sensor element may not only determine the spectrum of the light being reflected from the object, but also the spectral distribution of the light being emitted onto the object. Therefore the color sensor element may comprise a processor, which compares the measured spectrum with a target spectrum and controls the light emitting means in the lighting element. The control information enables the lighting element to re-adjust itself, if errors in the emitted light distribution occur. In this embodiment the second spectrum of the inspection element may serve as a norm, enabling the color sensor to detect deviations in the first respectively third spectrum.

According to an advantageous embodiment, the inspection element is a torch light. So the inspection element would be mobile and the human inspector could illuminate only those objects, which he thinks are of interest. There would be no need to illuminate the whole place with both, the lighting element and the inspection element. Additionally, the torch light could be combined with the color sensor element. The color sensor element would determine the current light spectrum only from a small target area; the processor would compare this spectrum with the target spectrum and control the associated lighting element such that it produces a spectrum complementary to the initially measured spectrum, such that the target spectrum can be obtained in the target area.

The object of the invention is also achieved by a greenhouse with an illuminating device, according to any of the described examples, wherein the first and the third light emitting means are tuned according to the chlorophyll absorption curves.

The illuminating device and the underline principle may be used in all applications, where different light conditions are used for functional and inspection purpose. So the illumination device may be used in animal breeding, whereas a certain light spectrum may be desirable for animal comfort and a result or a white inspection light may be desirable to check animal's health or other bio parameters. For example, hematocryal animals are often held in reddish light caused by infrared emitting lamps. Another application of the described illuminating device is a production or assembly line. There the dedicated light may be used to set conditions for automatically inspections. However, in order to allow a human a visual inspection of a product or assembly line a white light as achieved with the described illumination device may be needed.

The aforementioned usage of an illuminating device, as well as claimed components and the components to be used in accordance with the invention in the described embodiments are not subject to any special exceptions with respect to size, shape, material selection as technical concept such that the selection criteria are known in the pertinent field may be applied without limitations. Additional details, characteristics and advantages of the object of the present invention are disclosed in the subclaims and the following description of the respective figures—which are an exemplary fashion only—shows three preferred embodiments of the illumination device according to the present invention.

These figures are:

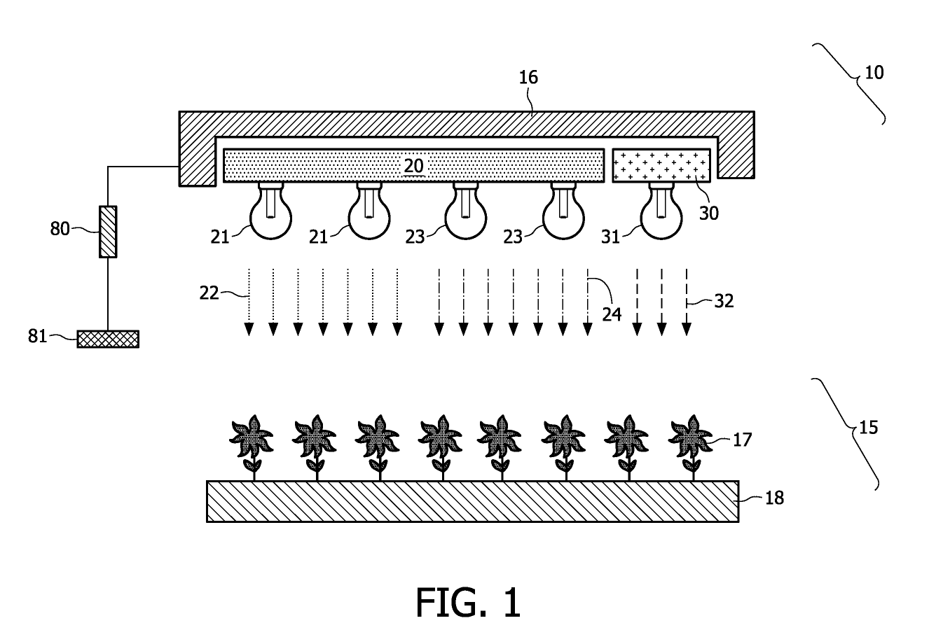

FIG. 1 shows a schematic view of an illuminating device with a lighting element and an inspection element,

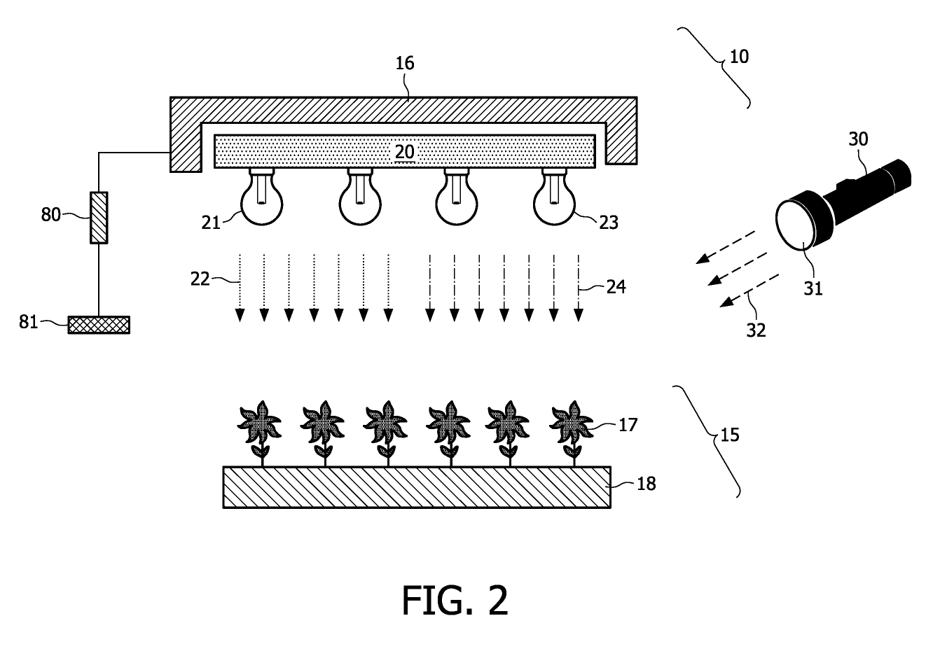

FIG. 2 shows a schematic view of the illuminating device with an inspection element being a torch light according to a second embodiment of the present invention, and

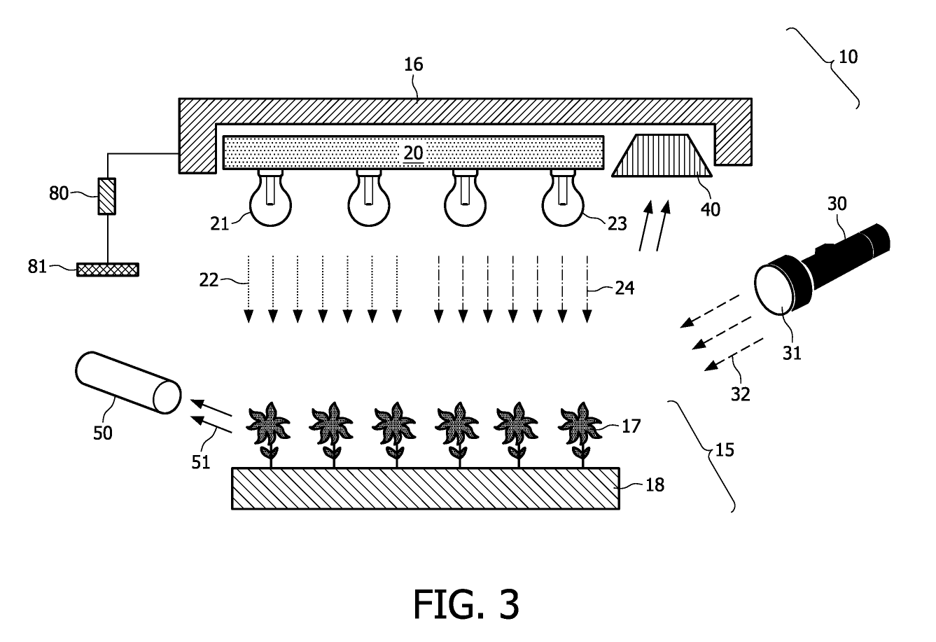

FIG. 3 shows an illuminating device according to a third embodiment.

FIG. 1 shows a schematic view of an illumination device 10 with a lighting element 20 and an inspection element 30. Subjacent to the illuminating device 10 an object 15 is arranged, being in the shown case a carrier element 18 for a soil or a substrate in which plants 17 are embedded. The lighting element 20 comprises a plurality of a light emitting mean 21 and a third light emitting mean 23. As indicated by different types of lines the first light emitting mean 21 and the third light emitting mean 23 emit light with different spectra 22, 24. In horticultural application like the one shown in FIG. 1 it is appropriate to emit light in the blue absorption region and the red absorption region, because only these two light regions are absorbed by Chlorophyll A and B. Therefore a composite light of blue and red optical light is sufficient to grow the plants 17. The drawback of this light spectrum is that a human inspector is not able to determine the health conditions of the plants 17. Therefore a result light or preferred a white light would be needed. To achieve this aim, the illumination device can be operated in an inspection mode, in which contrary to the illumination mode the lighting element as well as the inspection element is operated.

To produce a white light the illumination device 10 comprises at least one second light emitting mean 31, wherein the second light emitting mean 31 is emitting light with a second spectrum 32, being essentially separated from the first spectrum 22 and the third spectrum 24. This second spectrum 32 adds the missing components of the optical spectrum to achieve a white light. In a supposed horticultural application the missing spectrum would be a green optical spectrum.

With the term spectrum a distribution of the wavelength of the light being emitted by one of the three light emitting means is described. Therefore a red optical spectrum comprises a wavelength distribution with a peak wavelength within the red optical spectrum between 600 nm to 700 nm. If for one of the light emitting means a LED or an OLED is used, the spectral distribution will be partially Gaussian.

According to FIG. 1 the light emitting element 20 and the inspection element 30 are mounted together in one mounting 16. Both elements 20, 30 are connected to a driver 80 and a source 81. Both of those 80, 81 are part of an electrical power supply to drive the light emitting means 21, 23, 31. The lighting element 20 and/or the inspection element 30 may comprise several LEDs or OLEDs arranged within an array. As OLEDs are large area light sources, which may have a size of for example 30×30 cm or larger, one can easily cover even large illuminating devices 10. As the second light emitting mean 31 is only needed in the inspection mode, it is useful that the number of the first 21 and the third light emitting means 23 are larger than the number of the second light emitting means 31.

In contrast to the one-piece implementation of the illuminating device 10, FIG. 2 shows a two-piece embodiment of the invention. In this case the inspection element 30 is a torch light. This embodiment has the advantage, that only a small target area is illuminated with the light of the inspection element 30 and there is no need to change the lighting conditions of the whole area being illuminated by the lighting element 20. The object 15 is constantly exposed to the superimposed light flux of the first 21 and the third light emitting mean 23. During the inspection mode the plants 17 are only partially exposed to white light because only small areas are illuminated by the portable inspection element 30.

FIG. 3 shows an illuminating device 10 with a lighting element 20, which is positioned together with an analyzing element 40 in one mounting 16. This mounting 16 is positioned above the illuminated object 15. The analyzing element 40 detects a light output of the lighting element 20 and the wavelength of the light. With the help of this two information an overall light output of the lighting element 20 can be calculated. Whether the inspection element 30 is integrated with the lighting element 20 in a mounting 16 or the inspection element 30 is a torch light, in both cases the number of the second light emitting means 31 may be smaller than the number of the first and the third light emitting means 21, 23. Therefore the integral light flux of the lighting element 20 will be larger than the integral light flux being emitted by the inspection element 30. To achieve the white light, a steady light flux in all wavelength intervals is needed. Therefore the light output of the lighting element 20 may be adjusted to an output level of the inspection element 30. By using the information measured by the analyzing element 40 in combination with the known light flux of the inspection element 30 an iterative control loop may be established to adjust the light output of the lighting element 20 to achieve a white light in the inspection mode.

In FIG. 3 also a color sensor element 50 is illustrated. The color sensor element 50 detects a reflected spectrum 51 from the object 15, being illuminated in the illuminating mode or the inspection mode. The reflected light with the spectrum 51 entering the color sensor element 50 is made incident on a dispersing optical element, which may be a prism, a diffraction grating, a holographic optical element or any other suitable element. Subsequent the reflected light dispersed by the dispersing optical element is made incident on a linear detector array, which may be a CCD array.

The information concerning the spectral distribution of the reflected light measured by the color sensor element 50 may be send as a control information to the illumination device 10 or a central computer system controlling the light conditions in a greenhouse. With the control information it is possible to adjust the output level of the light with the first spectrum 22 and/or the third spectrum 24. Furthermore, the color sensor element 50 may comprise a processor which compares the measured spectrum with the target spectrum to determine possible deviations. The color sensor element 50 may either be a separate element or part of the inspection element 30. In the last named case it is advantageous if the inspection element 30 is a torch light, so that the color sensor element 50 may analyze the reflected light within a target area, which is illuminated by the inspection element 30.

### LIST OF NUMERALS

10 illuminating device
15 object
16 mounting
17 plant
18 carrier element
20 lighting element
21 first light emitting mean
22 first spectrum
23 third light emitting mean
24 third spectrum
30 inspection element
31 second light emitting mean
32 second spectrum
40 analyzing element
50 color sensor element
51 reflected spectrum
80 driver mean
81 source

1. An illuminating device for illuminating an object, the illumination device comprising a lighting element and an inspection element,
wherein the lighting element comprises at least one first light emitting means for, emitting light with a first spectrum,
wherein the inspection element comprises at least one second light emitting means for emitting light with a second spectrum,
wherein the second spectrum is essentially separated from the first spectrum, the illumination device operating in either an illuminating mode, operating only the lighting element, or an inspection mode, operating the lighting element and the inspection element such that the superposition of the light of the first and the second light emitting means yields a resultant light.

2. An illuminating device according to claim 1, wherein the resultant light is a white light.

3. An illuminating device according to claim 1, wherein the lighting element comprises at least one third light emitting mean, wherein the third light emitting mean is emitting light with a third spectrum, wherein the third spectrum is essentially separated from the first and the second spectrum.

4. An illuminating device according to claim 3, wherein the first, the second and the third light emitting mean are a LED, an OLED or a gas discharge lamp.

5. An illuminating device according to claim 1, wherein the first spectrum comprises a peak wavelength within the red optical spectrum, the third spectrum comprises a peak wavelength within the blue optical spectrum and the second spectrum comprises a peak wavelength within the green optical spectrum.

6. An illuminating device according to claim 1, wherein the number of the first and the third light emitting means are larger than the number of the second light emitting means.

7. An illuminating device according to claim 1, wherein the illuminating device comprises an analyzing element (40), detecting a light output of the lighting element and adjusting the light output to an output level of the inspection element.

8. An illuminating device according to claim 1, wherein the illuminating device comprises a color sensor element, detecting a reflected spectrum from the object, being illuminated in the illuminating mode or the inspection mode.

9. An illuminating device according to claim 8, wherein the color sensor element communicates with the lighting element, wherein the color sensor element sends a control information to the lighting element for adjusting an output level of the light with the first spectrum and the third spectrum.

10. (canceled)

11. The illuminating device according to claim 1, wherein the first and third light emitting means are tuned according to the chlorophyll absorption curves.
